(19) United States
(12) Patent Application Publication
(10) Pub. No.: US 2026/0316909 A1
(43) Pub. Date: Oct. 15, 2026

(54) Transom Plugs to Provide Flush Surface for Transom-Mounted Water Stabilization Device

(71) Applicant: SEAKEEPER, INC., California, MD (US)

(72) Inventors: Anthony Loreto, North Fort Myers, FL (US); Andrew Semprevivo, Punta Gorda, FL (US); Daniel Corrada, Fort Myers, FL (US)

(21) Appl. No.: 19/565,125

(22) Filed: Mar. 12, 2026

Related U.S. Application Data
(60) Provisional application No. 63/786,513, filed on Apr. 10, 2025.

(51) Int. Cl. B63B 83/00; B63B 1/24; B63B 59/00

(52) U.S. Cl. CPC B63B 83/00; B63B 1/242; B63B 59/00

(57) ABSTRACT

A method for adapting a transom and hull of a watercraft to receive a flush-mounted water stabilization device. The method includes coating a trim pocket in a transom of a watercraft with a wax or a mold release agent, applying a gel and fiberglass matrix to the coated trim pocket, filling a remaining void of the coated trim pocket with a core. An exterior of the core is made level with adjacent flat surfaces of the transom. The core is used to form a mold cavity, used to make one or more transom plugs. The resulting transom plugs are bonded into the trim pockets, rendering the transom sufficiently flat to receive one or more flush-mounted water stabilization devices.

### CROSS REFERENCE TO RELATED APPLICATIONS

This application claims the benefit of the filing date, under 35 USC § 119(e), of US Provisional Application No. 63/786,513, filed Apr. 10, 2025, the entirety of which is hereby incorporated by reference.

### FIELD OF THE DISCLOSURE

This disclosure relates generally to water stabilization devices for watercraft, and more specifically, to methods for adapting the transom of a vessel to provide a flush surface to which a transom-mounted water stabilization device may be secured.

### BACKGROUND

Watercraft are often provided with pockets, or recesses, in the transom plate at the aft of the vessel to receive trim tabs. A transom-mounted vessel attitude control system that outperforms conventional trim tabs requires a flush transom surface. The pockets or recesses provided to accommodate conventional trim tabs interrupt the flush transom surface. It is desirable to modify the transom of a watercraft having trim tab pockets or recesses to provide a flush transom surface on which a transom-mounted water stabilization device may be secured. With the support of additive manufacturing technology, such as 3D printing, there is increased opportunity to employ methods to facilitate the conversion of trip pockets in the transom of watercraft to flat transoms.

### SUMMARY

We have developed methods of modifying a transom of a vessel to provide molded fiberglass inserts, or alternatively, 3D printed plugs, to fill trim tab pockets, or recesses, along the transom in order to adapt the transom so as to have a continuous flush surface to accommodate a transom-mounted water stabilization device. A first step of transom pocket filling for conversion to a flat transom is removing any trim tabs from the transom of the vessel hull. According to a first method of the present disclosure, a wax coating or mold release agent is applied to at least one trim pocket or recess (and, if the size and/or geometry of any of a plurality of trim pockets along the transom is different from the geometry of any other of trim pockets along the transom, such as if one or more starboard trim pockets has a distinct size and/or geometry from one or more port trim pockets along the transom, then applying the wax coating or mold release agent to each uniquely sized and/or shaped tab pocket). Then, a gel goat, chopped strand mat (CSM), and/or biaxial fiberglass fabric or tape is applied to the coated interior of the trim pocket(s).

Additionally, a core is filled into the remaining void(s) to fill each coated trim pocket, an exterior of the core level with adjacent flat surfaces of the hull bottom and transom. After the core is cured, it is withdrawn from the pocket, and used to form a mold cavity in which a plug is then formed. Upon ejecting that plug from the mold cavity, the plug is faired, gel coated, and finished, and a quantity of plugs at least equal to the number of pockets having that plug size and geometry is formed, each of which can then be bonded to the trim pocket. For each specific trim pocket that was used to form the core, the wax coating or mold release agent is removed and the trim pocket cleaned prior to bonding the plug. Methyl methacrylate adhesives (MMA or acrylic adhesives) are particularly suitable for bonding the plugs into the trim pockets. Boundaries between each plug and the surrounding hull and transom may be sealed with silicone or calk.

Once plugs have been installed in each of the trim pockets and sealants have cured, a transom-mounted water stabilization device can be secured to the now-flat surface of the transom.

Alternatively, instead of forming a plug, each trim pocket can be permanently filled to build up surfaces that are flush with the adjacent transom plate and hull, to then install transom-mounted water stabilization devices as desired, but this process would need to be repeated for each trim pocket and watercraft, without the advantage of having a repeatable manner of forming a plug for all trim pockets of the same size and geometry.

In an alternative process, suitable CAD models of transoms having trim pockets, such CAD models are used to generate, using 3D-printing or another additive manufacturing process, plugs without having to first generate a core that is then ejected and used to generate a mold from which plugs are formed. Rather, the 3D-printing or other additive manufacturing process is performed to generate as many plugs of each size and geometry needed to fill the transom pockets of the watercraft. An inventory of the plugs can be manufactured and retained for use in retrofitting future watercraft of the same trim pocket sizes and shapes, or for use in repairing previously-retrofitted watercraft to restore the transom surface to a flat surface to which a water stabilization device may be secured.

The 3D printed transom plugs may be printed with up to 100% infill, but more preferably, are printed with gussets in a shell and rib technique so as to minimize infill. As 3D printing parts with infill requires increased print time, each transom plug is preferably 3D printed as a plurality (two or more) of smaller components that dovetail together. By 3D printing each plug as a plurality of smaller components, the production load of 3D printing transom plugs may be distributed among a plurality of 3D printers, even to 3D printers at different physical locations from one another. While some trim pockets may have overall dimensions small enough to 3D print a complementary transom plug using a single 3D printer, which may have a typical working area (maximum 3D printed part size) of 10”x10”x10”, some trim pockets have dimensions significantly exceeding the typical 3D printer working area, such as up to 20”x20”x20”. By 3D printing the transom plugs in component parts, transom plugs may be produced for even trim pockets having sizes exceeding the maximum working area of a typical 3D printer.

Because portions of the trim pockets of watercraft are exposed to the bottom of the hull, when forming the transom plugs it is desirable to produce the transom plugs in a manner that results in any surfaces of the transom plug that will be exposed to the hull bottom when installed in a trim pocket to be as smooth a surface as possible, as this will avoid unnecessarily imparting hydrodynamic turbulence, which might negatively impact ride comfort or require additional actuations of the water stabilization devices to be secured to the transom to dampen. Because the print bed of a 3D printer is smooth, the transom plug components are 3D printed in a manner that the surfaces of the components that are to be exposed to the hull bottom when the components are assembled into a transom plug and inserted into a trim pocket are printed facing the print bed.

The components of the transom plugs are 3D printed in a manner that results in transom plugs having sufficiently high tensile strength and low water absorption to avoid the need for fiberglass or laminated coatings. The tensile strength of the transom plugs is enhanced by 3D printing the transom plug components in a manner that deposits layers of material used in the additive manufacturing process such that striations will be oriented perpendicularly to the maximum tensile forces the transom plugs will experience once installed.

### BRIEF DESCRIPTION OF THE DRAWINGS

FIG. 1 is a flow chart illustrating a method of modifying a transom of a watercraft having trim pockets or recesses to receive a transom-mounted stabilization device;

FIG. 2 is a left (port-side), bottom, rear (aft) perspective view of a watercraft having a trim pocket in a transom and hull bottom;

FIG. 3 is a plug formed according to the method of FIG. 1, to be installed in the trim pocket in the transom and hull bottom of FIG. 2;

FIG. 4 is a left, bottom, rear perspective view of the watercraft of FIG. 2, with the plug of FIG. 3 installed in the trim pocket in the transom and hull bottom to provide surfaces that are contiguous with adjacent surfaces of the transom and hull bottom;

FIG. 5 is a right (starboard-side), bottom, rear (aft) perspective view of a watercraft having a trim pocket in a transom and hull bottom, with a trim tab removed therefrom and wax or spray mold release applied to the trim pocket and surrounding areas;

FIG. 6 is a right, bottom, rear perspective view of the coated trim pocket with gel coat, CSM, and/or fiberglass applied thereto;

FIG. 7 is a right, bottom, rear perspective view of the trim pocket filled with a core;

FIG. 8 is a perspective view of a shell of the cured core after removal from the trim pocket;

FIG. 9 is a molded transom plug;

FIG. 10 is a plug being ejected from a mold;

FIG. 11 is a rear (aft) view of a transom with a transom plug received in each trim pocket and port and starboard-side water stabilization devices secured to the transom;

FIG. 12 is a flow chart illustrating a method of 3D printing a transom plug for modifying a transom of a watercraft having trim pockets or recesses to receive a transom-mounted stabilization device; and

FIG. 13 is a plan view of a plurality of 3D-printed transom plug components that, when assembled, define a transom plug.

### DETAILED DESCRIPTION

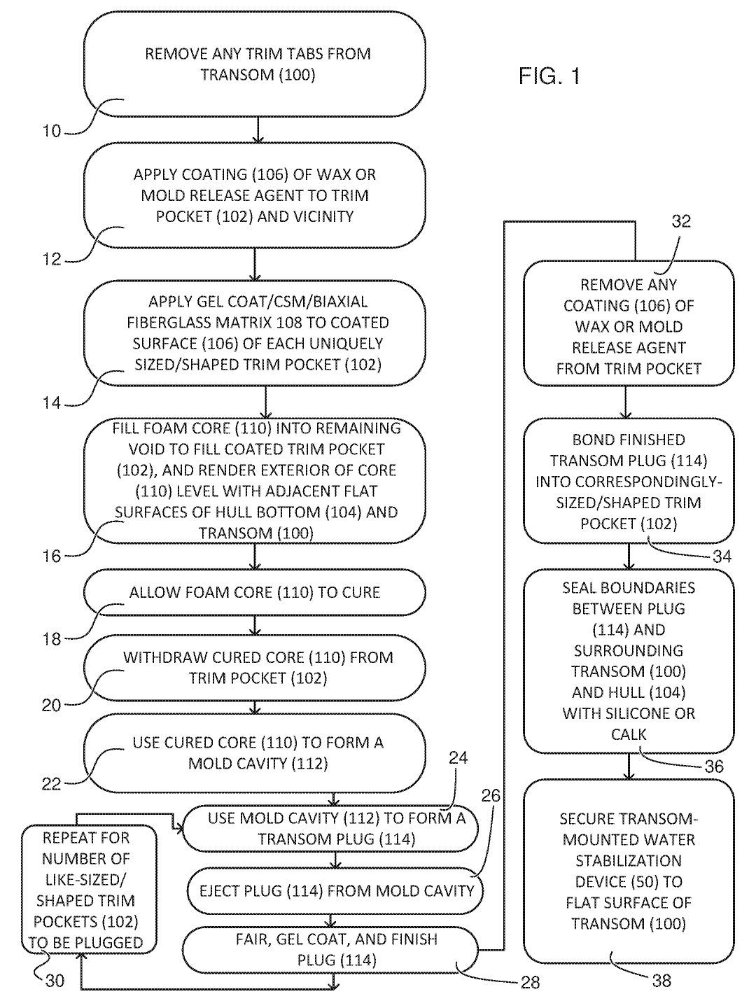

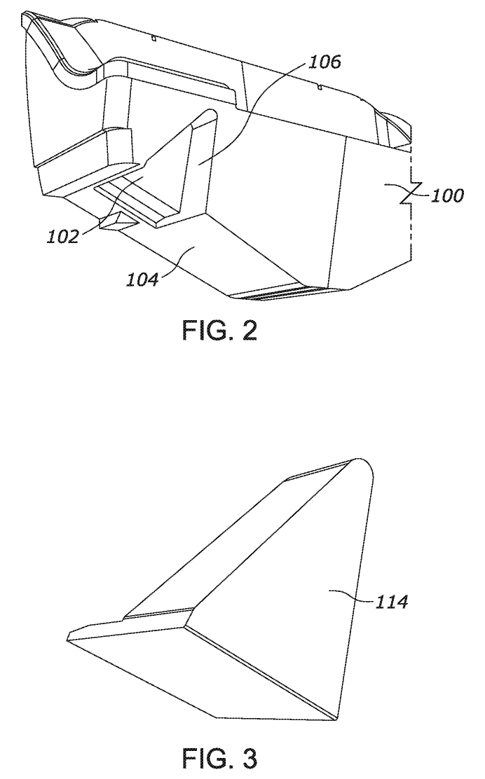

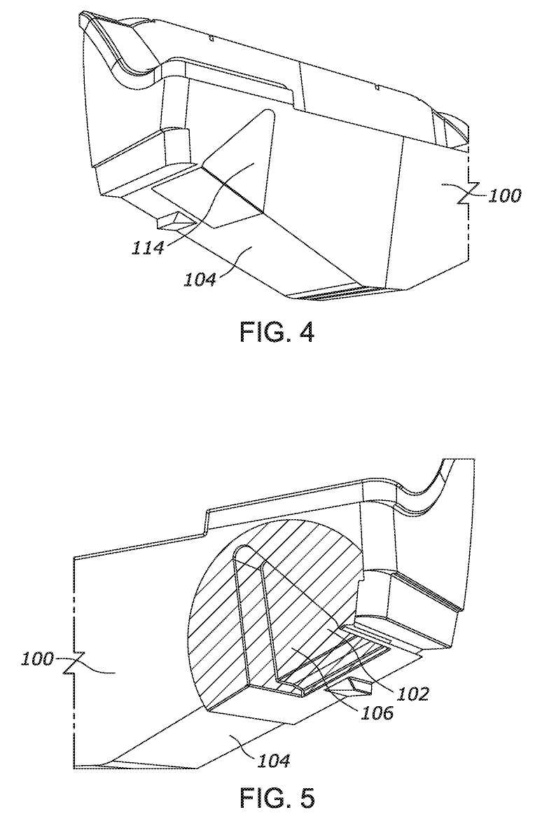

As illustrated in the flow chart of FIG. 1, a method is provided for filling each transom pocket of a transom of a watercraft so as to prepare the transom of the watercraft to receive a flush-mounted water stabilization device 50. In a first step, 10, any trim tabs are removed from the transom plate 100. In step 12, each uniquely-sized trim pocket 102 in the transom plate 100 (a portion of which may also be exposed to the hull 104 on an underside of the watercraft), as well as a surrounding vicinity of the trim pocket 102, is coated with at least one of a wax and a mold release agent to form a coating 106 on the exposed interior of the trim pocket 102, as illustrated in FIG. 5.

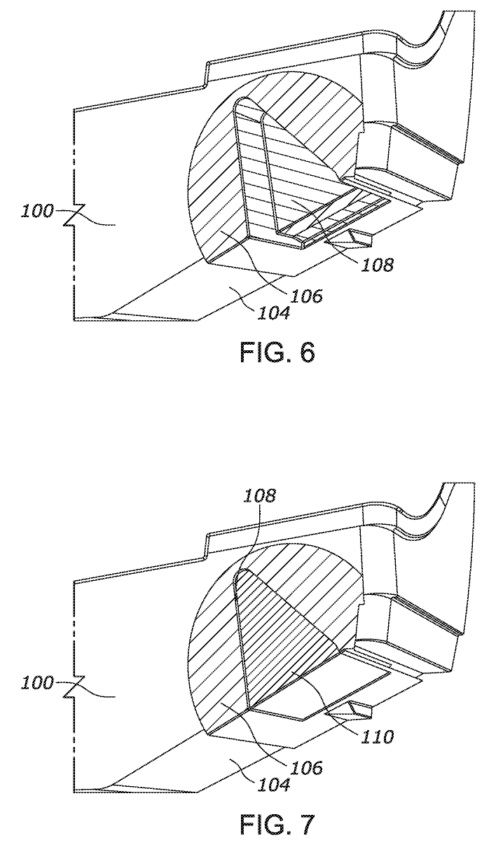

In step 14, a gel coat and fiberglass matrix 108, including a chopped strand mat (CSM) and/or fiberglass (e.g., a biaxial fiberglass) fabric or tape, is applied to each uniquely sized and/or shaped coated trim pocket 102, as illustrated in FIG. 6. In step 16, the remaining void of each such trim pocket 102 is filled with a core 110, as illustrated in FIG. 7, and the exterior of that core 110 is brought level with adjacent flat surfaces of the hull bottom 104 and the transom plate 100. The core 110 is then allowed to cure, as indicated in step 18 in the flow chart of FIG. 1.

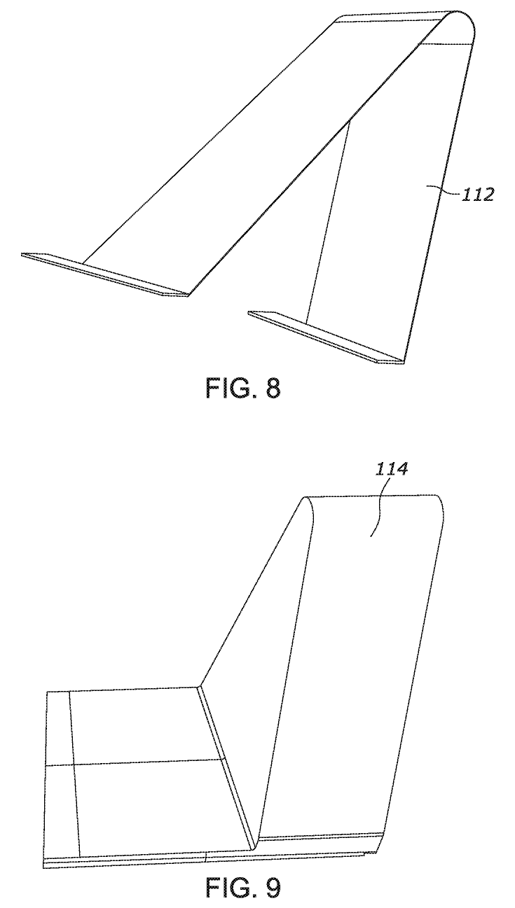

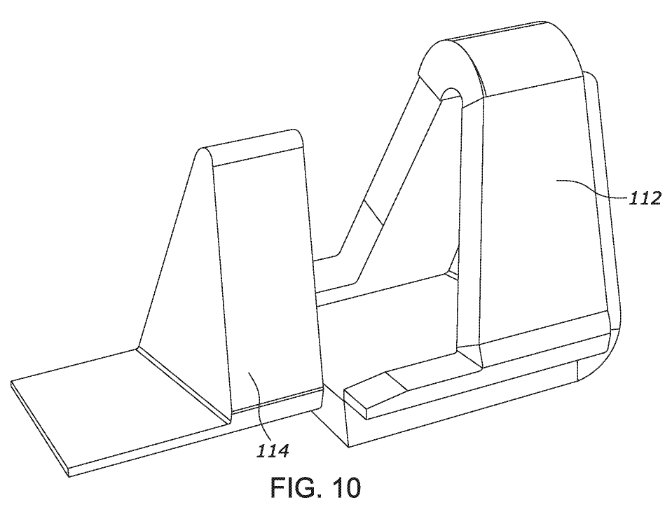

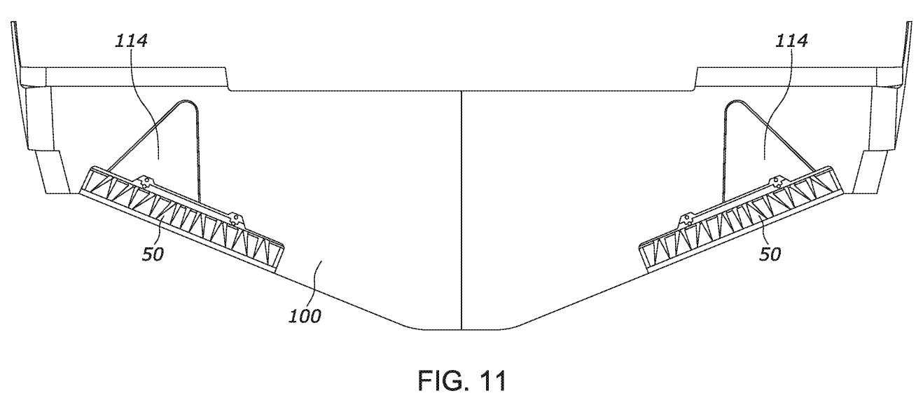

As indicated in step 20, the cured core 110 is then withdrawn from the trim pocket 102, and in step 22, that withdrawn core 110 is used to form a mold cavity 112, such as indicated in FIG. 8. Step 24 involves use of that mold cavity 112 to form a transom plug 114. In step 26, the transom plug 114 is then ejected from the mold cavity 112. As indicated at 30, steps 24, 26, and 28 are repeated until at least a number of transom plugs 114 are formed that corresponds to a number of like-sized and shaped trim pockets 102 to be plugged.

As indicated in step 32, any remaining coating 106 of wax or mold release agent is removed from the trim pocket 102 that was used to form the core 110 from which the mold cavity 112 was created. In step 34, each transom plug 114 is bonded into a correspondingly-sized and shaped trim pocket 102 using a suitable sealant, such as a marine grade two-part epoxy. Next, as indicated in step 36, boundaries between the transom plug 114 and surrounding transom plate 100 and hull 104 are sealed with silicone or calk.

With the transom plugs 114 having converted the transom 100 to a substantially continuous flat surface, one or more transom-mounted water stabilization devices 50 are secured to the transom 100, such as one water stabilization device 50 on a port side of the transom 100 and another water stabilization device 50 on a starboard side of the transom 100.

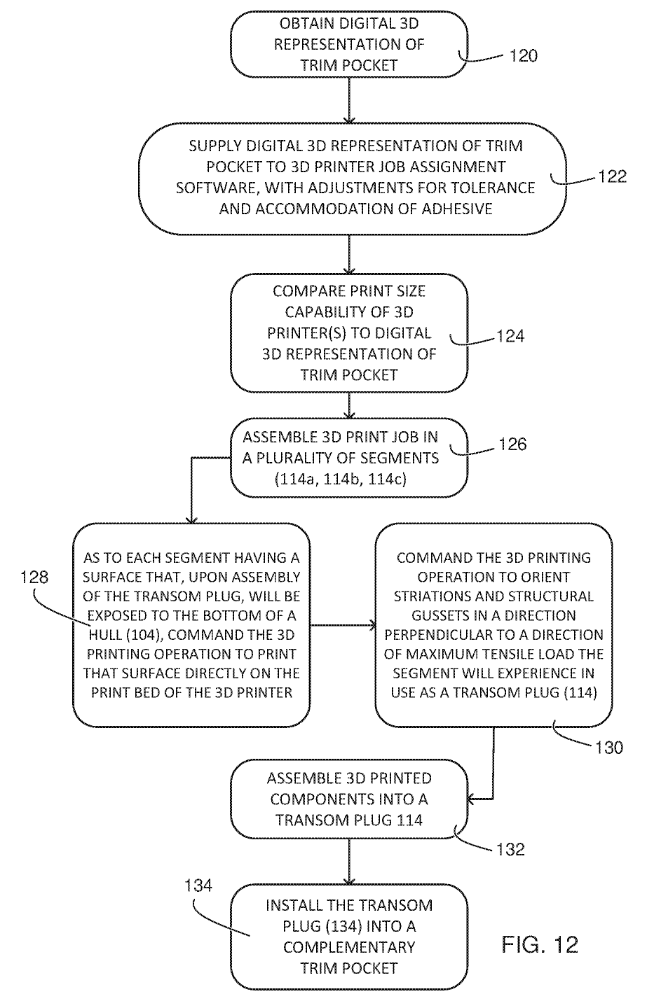

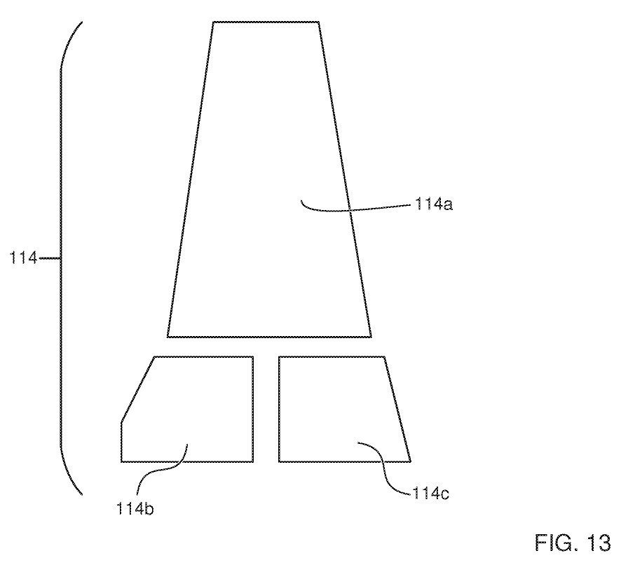

In an alternate embodiment, with the benefit of CAD data or 3D scanning, a transom plug 114 may be produced, such as by 3D printing or other additive manufacturing process, without having to form a mold. Turning to FIG. 12, a method is provided for employing additive manufacturing processes, such as 3D printing, to form a transom plug for filling each transom pocket of a transom of a watercraft in order to prepare the transom of the watercraft to receive a flush-mounted water stabilization device 50. As indicated in step 120, a digital 3D representation of a trim pocket, for which a transom plug 114 is to be formed, is obtained. The 3D representation of the trim pocket may, for example, be obtained from a pre-existing source, such as the watercraft manufacturer, or alternatively, may be generated using a 3D scanner.

In step 122, the digital 3D representation of the trim pocket is supplied to 3D printer job assignment software, such as read/writeable 3D printer control instruction software stored on a non-transitory computer-readable medium, associated with a computer processor, which software adjusts the dimensions of the trim pocket to calculate dimensions of transom plug components 114a, 114b, 114c (also referred to herein as segments) to be 3D printed and assembled to form a transom plug 114. The adjustments take into consideration tolerances as well as leaving appropriate spacing to accommodate adhesive to retain the transom plug 114 in a complementary trim pocket.

In step 124, the print size capability, also known as the working area, of the 3D printer(s) to be used to produce the transom plug components 114a, 114b, 114c is compared to the dimensions of the 3D digital representation of the trim pocket (as adjusted according to step 122). It is then determined, using the 3D printer job assignment software, the dimensions of each transom plug component 114a, 114b, 114c to be 3D printed, which is indicated in step 126 of the flow chart of FIG. 12 as “assemble 3D print job in a plurality of segments.” By tasking a plurality of 3D printers with printing the distinct transom plug components 114a, 114b, 114c, the load of 3D printing the transom plug 114 is distributed, which can reduce the overall 3D printing time.

In step 128, it is determined, which determination may be facilitated by using the 3D printer job assignment software, as to each transom plug component 114a, 114b, 114c to be printed, whether that transom plug component has a surface that, when the transom plug 114 is assembled and installed in a trim pocket, will be exposed to the bottom of the hull 104 of the watercraft. To minimize hydrodynamic turbulence imparted by surface texture of 3D printed components, it is desirable to arrange the transom plug component 114a, 114b, 114c such that the smoothest surface of the assembled transom plug 114 faces the bottom of the hull 104. The 3D-printed surface printed directly on the bed of the 3D printer is typically the smoothest surface of a 3D-printed part. Therefore, as to each transom plug component 114a, 114b, 114c having a surface that, upon assembly of the transom plug 114, will be exposed to the bottom of the hull 104, the 3D printer job assignment software commands the respective 3D printer tasked with 3D printing that transom plug component 114a, 114b, 114c to perform the 3D printing operation in such a manner that the surface of that transom plug component 114a, 114b, 114c which will be exposed to the bottom of the hull 104 when assembled into a transom plug 114 and installed in the complementary trim pocket is printed first, such that it is the surface printed directly on the bed of the 3D printer.

In step 130, a direction of maximum tensile load likely to be experienced by the resulting transom plug 114 when installed and while the watercraft, with the flush-mounted water stabilization device 50 installed on the flattened surface of the transom provided by the transom plug 114, is determined. Based on that direction, the 3D printer job assignment software commands the 3D printer to print the transom plug component 114a, 114b, 114c in such a manner that striations and/or gussets within the transom plug component 114a, 114b, 114c are oriented in a direction perpendicular to the direction of maximum tensile load the segment will experience in use as a transom plug 114. The transom plug components 114a, 114b, 114c are preferably 3D printed using PTEG (Polyethylene Terephthalate Glycol). The transom plug components 114a, 114b, 114c are preferably printed in a shell and rib or gusset technique so as to minimize infill.

According to step 132, the 3D printed components 114a, 114b, 114c are assembled into a transom plug 114. In step 134, the assembled transom plug 114 is installed into a complementary trim pocket. As needed, the installed transom plug 114 may be sanded, such as with an 80 grit sandpaper, until flush with the transom plate 100.

Transom plugs 114 that are 3D printed in the above-described manner are found to have favorably-low water absorption properties in the submerged environments for which they are to be used, and their high tensile strength and durability are sufficient to avoid the need for fiberglass coatings, fabrics, skins, or tapes.

In 3D printing the transom plug components 114a, 114b, 114c, the components may be printed in a manner that reduces the need for sacrificial material that would otherwise need to be printed and removed to provide support, such as for particular rib geometries. It is found that 3D printing the transom plug components 114a, 114b, 114c in a manner that provides ribs with triangular tops gradually spreads out the print material (e.g., PTEG) until it reaches the horizontal structure. Employing this technique advantageously supports maintaining high print speed and reduces post-printing processing time and effort.

It is also found that it is beneficial to 3D print the transom plug components 114a, 114b, 114c in a manner that provides 3D printed stand-offs on the printed component to prevent adhesive from being pushed out and ensure a proper bond line. The stand offs may be conical in shape to facilitate printing without the need for sacrificial support material.

The 3D printed transom plug components 114a, 114b, 114c may be printed, or otherwise provided, with some indicia to indicate where the transom plug components 114a, 114b, 114c, or the resulting transom plug 114, is to be located on a particular watercraft (such as an identification of a particular trim pocket into which the transom plug 114 is to be installed), and/or with information to facilitate installation on the transom plate 100 of a flush-mounted water stabilization device. For instance, the indicia may include mounting screw hole location or lines to facilitate alignment of the transom plate of the water stabilization device 50. Other indicia may include make and model information, or other information to help identify and differentiate transom plug components 114a, 114b, 114c. While FIG. 13 illustrates three transom plug components 114a, 114b, 114c, it is understood that a transom plug 114 may be 3D printed (or otherwise formed) using fewer or more than three components within the scope of the present disclosure.

If desired, accessories, such as LED lights, can be provided in the transom plugs 114.

While the invention has been described with respect to particular embodiments, it will be understood that variations may be made thereto that are still within the scope of the appended claims.

What is claimed is:

1. A method for adapting a transom and hull of a watercraft to receive a flush-mounted water stabilization device, comprising:
coating a trim pocket in at least one of a transom or hull of a watercraft with at least one of a wax and a mold release agent;
applying at least one of a gel coat and a fiberglass layer to the coated trim pocket;
filling a remaining void of the coated trim pocket with a core;
flattening an exterior of the core so as to be level with adjacent flat surfaces of the transom and hull of the watercraft;
once cured, withdrawing the cured core;
forming a mold cavity using the cured core;
forming a plug using the mold cavity; and
bonding the formed plug into the trim pocket.

2. The method of claim 1, further comprising, prior to bonding the formed plug into the trim pocket, removing any of the wax or mold release agent from the trim pocket.

3. The method of claim 1, and forming additional plugs using the mold cavity for at least as many additional trim pockets are provided in the at least one of the transom or hull having a size and a shape the same as the trim pocket.

4. The method of claim 1, and repeating the steps of the method for each additional trip pocket provided in the at least one of the transom or hull having at least one of a size or a shape different than the trim pocket.

5. A method of forming a transom plug, comprising:
obtaining a digital 3D representation of a trim pocket;
supplying the digital representation of the trim pocket to a read/writeable set of 3D printer control instructions,
comparing a print size capability of a 3D printer to the digital representation of the trim pocket;
develop a set of 3D printer operating instructions to 3D print a plurality of components that, when assembled, cooperate to define a transom plug;
3D print each of the components; and
assemble the components into a transom plug.

6. The method of claim 5, wherein in developing the set of 3D printer operating instructions to 3D print a plurality of components that, when assembled, cooperate to define a transom plug, as to each segment having a surface that, upon assembly of the transom plug, will be exposed to the bottom of a hull of a watercraft having a trim pocket into which the transom plug is to be installed, commanding the 3D printing operation for that component to print that surface directly on a bed of a 3D printer.

7. The method of claim 5, and in developing the set of 3D printer operating instructions to 3D print a plurality of components that, when assembled, cooperate to define a transom plug, commanding the 3D printing operation to orient at least one of a group including gussets and striations of the component in a direction perpendicular to a direction of maximum tensile load to which the component will experience in use as a transom plug.

8. The method of claim 5, further comprising installing the transom plug into a complementary trim pocket.
